(19) United States
(12) Patent Application Publication
(10) Pub. No.: US 2012/0240919 A1
(43) Pub. Date: Sep. 27, 2012

(54) LATENT HEAT STORAGE MATERIAL WITH PHASE CHANGE MATERIAL IMPREGNATED IN A GRAPHITE MATRIX, AND PRODUCTION METHOD

(75) Inventor: ALOIS BAUMANN, RAIN (DE)

(73) Assignee: SGL CARBON SE, WIESBADEN (DE)

(21) Appl. No.: 13/489,908

(22) Filed: Jun. 6, 2012

Related U.S. Application Data
(63) Continuation-in-part of application No. 12/144,291, filed on Jun. 23, 2008, now abandoned.

(30) Foreign Application Priority Data
Jun. 22, 2007 (DE) 10 2007 029 273.4

(51) Int. Cl. F24H 7/00; B32B 38/04; B32B 3/30; B32B 37/10

(52) U.S. Cl. 126/400; 156/308.4; 156/257; 428/166

(57) ABSTRACT

A latent heat storage material is formed of at least two plies of a compressible graphitic material in which graphite wafers are arranged substantially in layer planes lying one on the other and which is infiltrated with at least one phase change material. The surface of each ply is provided with a structuring reaching the outsides of the graphite material bundle. The evacuation and infiltration travel lengths in the layer planes, due to the structuring, amounts to a maximum of 200 mm.

### CROSS-REFERENCE TO RELATED APPLICATION

This application is a continuation-in-part application of copending patent application Ser. No. 12/144,291, filed Jun. 23, 2008, which claimed the priority, under 35 U.S.C. §119, of German patent application No. DE 10 2007 029 273.4, filed Jun. 22, 2007; the prior applications are herewith incorporated by reference in their entirety.

### BACKGROUND OF THE INVENTION

### Field of the Invention

The invention relates to a latent heat storage material which consists of at least two plies of a compressible graphitic material and is infiltrated with at least one phase change material and to a method for producing such a latent heat storage material.

Latent heat storage materials based on graphitic materials which are mixed, impregnated or infiltrated with a phase change material are known from the German published patent application DE 196 30 073 and from European patent application EP 1 598 406. The graphitic materials form a highly heat-conductive matrix for the substantially less heat-conductive phase change materials and therefore allow a better heat exchange of the latent heat storage materials thus obtained. In particular, for the production of simple moldings, the pressing of expanded graphite that is precompacted into boards is appropriate. Infiltration of moldings consisting of compacted expanded graphite is impeded by the low rate of penetration of phase change material. For such boards consisting of compacted expanded graphite, long process times for the evacuation and infiltration are necessary in order to avoid the situation where too little PCM is taken up. Disadvantageous here are long process times or a low storability or storage capacity of the latent heat storage material thus produced.

### BRIEF SUMMARY OF THE INVENTION

The set object of the invention is to specify a latent heat storage material and a corresponding structural device which includes at least two plies of a compressible graphitic material and is infiltrated with at least one phase change material. The set object of the invention, furthermore, is to provide a method for producing such a latent heat storage material.

With the above and other objects in view there is provided, in accordance with the invention, a graphite matrix body for latent heat storage material, comprising:

at least two plies of a compressible graphitic material with graphite platelets disposed substantially in layer planes lying one above the other and infiltrated with at least one phase change material;

each ply having a surface formed with a surface structuring reaching the outsides of said graphite material and defining evacuation and infiltration travel paths; and

a travel length of said evacuation and infiltration travel paths in said layer planes due to said structuring amounting to a maximum of 200 mm.

In accordance with an added feature of the invention, the travel lengths of the evacuation and infiltration travel paths in the layer planes due to the structuring amount to a maximum of 50 mm.

In other words, the objects of the invention are achieved with proposed structuring. The structuring promotes the evacuation of the graphite matrix and also the infiltration of the package with phase change material (PCM). Further, it improves the access to the PCM in the finished assembly and increases the corresponding amount of PCM and raises the capacity of the device. As a result of the structuring, the air included in the graphite matrix is removed more quickly and more completely and a faster infiltration of the graphite matrix and also a higher degree of filling with the phase change material are achieved.

The terms “infiltration” and “impregnation” as understood herein refer to molecular adhesion processes and to microscopic, capillary activity. Infiltration means that a material (i.e., PCM) permeates something (i.e., the graphite bulk) by penetrating its pores and interstices. The PCM which is infiltrated into the graphite matrix does not substantially alter the graphite matrix, but is rather “stored” in the interstices formed between the graphite platelet layers and inside the graphitic molecular structure. The process may also be referred to as saturation, where the PCM “saturates” the graphite matrix and the structural form and shape of the saturated graphite bundle remains substantially unchanged relative to the graphite bundle prior to its infiltration and impregnation with the PCM.

As best understood, the graphite material forms the structure of the matrix and, at the same time, acts as the primary thermal conductor. The fact that the heat transport paths into and out of the latent heat storage device are provided by the graphite matrix walls themselves, enables substantially the entire amount of the PCM (i.e., the heat storage material itself) to react, and to react quickly, to the introduction of heat content or to the extraction of heat content. During the introduction of heat, the PCM acts as a heat sink while it acts as a heat source during the extraction of heat.

The compressible graphite material used for improving the thermal conductivity of the latent heat storage material is produced in a way that is known per se by the thermal expansion of interstitial graphite compounds into so-called expanded graphite and by the subsequent compression of the expanded graphite into flexible sheets or into boards. Reference is had, for example, to U.S. Pat. No. 3,404,061, to German patent DE 26 08 866, and to U.S. Pat. No. 4,091,083, which are incorporated by reference herein.

The compressible graphite plies may already have the bulk density which is intended for them in the finished latent heat storage material. The pressure force applied when the plies of compressible graphite are pressed together to produce the latent heat storage material shall then not exceed the compression pressure required for achieving the given bulk density of the compressible graphite ply. However, even initially compressible graphite plies with a lower bulk density from the final bulk density in the finish-pressed latent heat storage material may be applied. Only then is the intended final bulk density generated when the components of the latent heat storage material are pressed together.

The groove depth in the rough-pressed article should preferably amount to at least 3.5 mm. The pressing of the rough-pressed articles into bundles, first in height and then in bundle width, does not result in a homogeneous degree of pressing of the strips. The degree of cross-linking of the strips decreases in the pressing direction and opposite to the pressing direction leads to ever smaller groove depths.

Pressing should preferably take place in the order that the bundles are first pressed width-wise and then height-wise. In this case, a height of 12.2+/−0.2 mm and a width of 30.7+/−0.2 mm of the rough-pressed articles, with grooves which are approximately 3.5 mm deep and approximately 4.5 mm wide, have proved to be advantageous. Preferably, 30-250 strips of the rough-pressed articles are pressed into a bundle.

As the individual strips are layered in plies, they are placed so that the surface structuring reaches the outsides of the pressed graphite material bundle. This, therefore, defining evacuation channels and infiltration channels. As a guide, the travel length of the evacuation and infiltration travel paths in the layer planes due to the structuring amounts to a maximum of 200 mm and, preferably, to no more than 50 mm.

The channels forming the surface structuring may be pressed or rolled into the plies of compressible material and the channels are preferably formed to have a cross section with sharp edges. In the alternative, the channels may be milled into the material. It is possible to provide individual strips that are then layered into a multilayer bulk. The strips may thereby be formed with the surface structuring (e.g., channels) prior to layering, or they may be placed to form a layer ply of the bulk and then the channels may be formed in each such layer before the next layer is placed on top.

The structuring is preferably in the form of channels formed in the surface of the ply material and having a ratio of depth to width in a range of 20:1 to 1:20. As the channels are formed on the surfaces of the plies, or the layer strips, the channels are arranged parallel to the graphite layers in the layered bulk.

The channels may be arranged in a variety of configurations, such as rectilinear, meandering, or a herringbone shape configuration. The channels are preferably arranged to extend in an evacuation and/or infiltration direction.

In a preferred process sequence, there are first provided a plurality of plies of a compressible graphitic material (e.g., expanded graphite). Up to 30% of a surface of each ply is provided with a structuring that reaches to the outsides of the material. Then two or more plies of the compressible graphitic material are placed in contact with one another, and the layered plies formed with the structuring are compressed at a temperature of up to 400° C. and at a pressure of between 0.1 MPa and 200 MPa.

Then the compressed bulk of expanded graphite is evacuated and infiltrated with phase change material. The evacuation and the infiltration may be effected in one direction or from one side.

Other features which are considered as characteristic for the invention are set forth in the appended claims.

Although the invention is described herein as embodied in a latent heat storage material and a production method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of the exemplary figures and of specific examples and comparative examples.

### BRIEF DESCRIPTION OF THE DRAWING FIGURES

FIG. 1 is a perspective view of a strip of expanded graphite formed into a shape according to the invention;

FIG. 2A is a partial top view of the strip shown in FIG. 1;

FIG. 2B is a partial top view of an alternative embodiment;

FIG. 2C is a partial top view of yet another alternative embodiment;

FIG. 3 is a perspective view of a bundle of strips according to FIGS. 1 and 2A partially assembled; and

FIG. 4 is a perspective view of an exemplary bundle assembled from the strips according to FIG. 2B.

### DESCRIPTION OF THE INVENTION

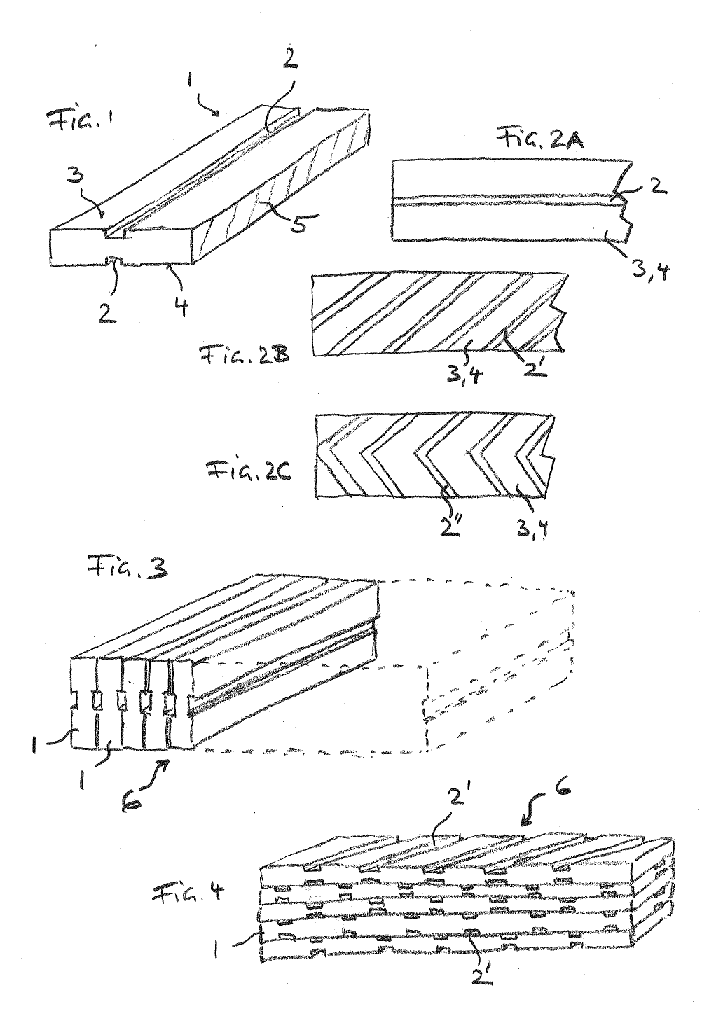

Referring now to the figures of the drawing in detail and first, particularly, to FIG. 1 thereof, there is shown an exemplary strip 1 formed by pressing expanded graphite. The strip 1 is formed with a central groove 2 which extends along its entire length in the center of the upper flat surface 3 and in the center of the lower flat surface 4. A graphite platelet alignment which is approximately 45° between the lower and upper surfaces 3, 4 is indicated on the side wall 5.

The dimensions of the strip are driven by the respective requirements posed of the resulting phase change material device. Here, the strip 1 has a length of approximately 50 centimeters (½ m), a width of approximately 4 centimeters, and a thickness of approximately 1.5 centimeters. A great variety of other dimensions are available. However, it is paramount that proper and efficient impregnation/infiltration of the strip is assured. Accordingly, the dimensions of the groove 2 (for efficient delivery of the PCM into the graphite and efficient heat exchange delivery) and also the distance of the groove from the remaining material are taken into account in selecting the dimensions.

FIG. 2B illustrates an alternative embodiment in which the grooves 2′ traverse the top surface 3 and the bottom surface 4 at an angle of 45° relative to the longitudinal extent of the strip.

FIG. 2C illustrates an alternative embodiment in which the grooves 2″ in the top surface 3 and the bottom surface 4 form a fishbone pattern. Many other designs are available, depending on the functional and structural requirements of the device.

With reference to FIG. 3, the individual strips 1 may be stacked into a bundle 6, with the strips 1 back-to-back so that the grooves 2 of adjoining strips 1 form flow channels for PCM into and out of the bundle 6.

FIG. 4 illustrates one of many further alternatives. Here, the strips 1 of FIG. 2B are stacked on one another. In addition, alternatively placed strips are offset from one another in the longitudinal direction by one half the spacing between the individual grooves 2′. This placement provides for a multitude of delivery channels that are relatively densely distributed about the bundle 6.

The invention will now be explained by way of a plurality of examples in which the inventive concept was implemented.

### Comparative Example 1

Strips of expanded graphite with the dimensions 480 mm length, 40 mm width, 15 mm thickness were layered and pressed into a bundle. The resulting bundle weight of the compacted graphite amounted to 862 g. The bundle was introduced into a bag and evacuated with the aid of a vacuum pump. The evacuation was driven to a subatmospheric pressure of 10 mbar. The evacuation time amounted to 220 s.

Infiltration with 3100 ml of water as phase change material subsequently took place. After storage for approximately six hours, approximately 300-400 ml of free water was still found. That is, approximately 2700-2800 ml of water infiltrated into a bundle of 862 g of compacted, expanded graphite.

### Comparative Example 2

In a similar way to example 1, a lighter bundle was assembled and pressed together. The bundle weight of the graphite amounted to 770 g. After an evacuation time of 220 s, infiltration with 3100 ml of water took place.

Here, the deformation of the bag (i.e., bladder) was quite pronounced. Sensor inoperative. Filling operation was concluded. The amount of free water remained quite large. After storage for approximately six hours, the remaining free water amounted to approximately 500-600 ml.

### Comparative Example 3

In a similar way to example 1, a bundle was assembled and pressed together. The bundle weight of graphite amounted to 757 g. Here, the evacuation time was increased to 500 seconds.

The filling operation with water took place approximately normally. Deformation of the bag was slightly greater. The bundle was firm after storage for 10 minutes. That is, the entire amount of water was infiltrated in the graphite matrix

### Example 1

Approximately 15 diagonal grooves were introduced by hand on each of the two sides of the strips at an angle of approximately 45° relative to the longitudinal extent. The bundle weight of the graphite was 775 g. The compressed bundle was evacuated for an evacuation time of 500 s.

The filling operation proceeded normally. Deformation of the bag was normal. The bundle was firm immediately. In other words, the water (i.e., PCM) entered the graphite matrix substantially immediately, without first forming a water pool in the bag.

### Example 2

Before pressing, two longitudinal grooves and four diagonal grooves were introduced on one side. The bundle weight of the graphite was 806 g and the evacuation time was set to 220 s.

The filling operation proceeded normally. The deformation of the bag was normal. The bundle was firm in the machine.

### Example 3

Two longitudinal grooves were introduced on one side by hand in series strips and the evacuation time was shortened. The bundle weight of graphite was 780 g and the evacuation time was set to 90 s.

The filling operation proceeded normally. The deformation of the bag was normal. The bundle was firm after storage of 10 minutes.

The results of further examples are illustrated in summary in Table 1.

| | | | Groove | Bundle weight | | | Result | |
|---|---|---|---|---|---|---|---|---|
| | Strip | | before | After | After | Evacuation | After | After |
| Example | Width | Height | pressing | pressing | filling | time | 10 s | 600 s |
| 11 | 11.8 | 41/40.1 | 3 | | | 90 sec. | free | |
| | | | | | | | water | |
| 12 | 11.8 | 41/40.1 | 3 | | | 90 sec. | free | firm |
| | | | | | | | water | |
| 13 | 11.8 | 41/40.3 | 3.5 | 579 | 3698 | 90 sec. | free | firm |
| | | | | | | | water | |
| 14 | 11.8 | 41/40.1 | 3.5 | 574 | 3449 | 90 sec. | free | firm |
| | | | | | | | water | |
| 15 | 10.7 | 41/40.5 | 3.5 | 582 | 3696 | 90 sec. | free | firm |
| | | | | | | | water | |
| 16 | 10.7 | 41/40.3 | 3 | 573 | 3739 | 90 sec. | free | firm |
| | | | | | | | water | |
| 17 | 10.7 | 41/40.4 | 3.5 | 571 | 3717 | 90 sec. | free | firm |
| | | | | | | | water | |
| 18 | 10.7 | 41/40.3 | 3.5 | 580 | 3678 | 90 sec. | free | firm |
| | | | | | | | water | |
| 19 | 10.7 | 41/40.4 | 3.5 | 578 | 3706 | 90 sec. | free | firm |
| | | | | | | | water | |

1. A graphite matrix body for a latent heat storage material, comprising:
at least two plies of a compressible graphite material with graphite platelets disposed substantially in layer planes lying one above the other;
each ply of said graphite material having a surface formed with a surface structuring reaching to a marginal surface thereof and thereby reaching to an outside of the graphite matrix body for defining infiltration channels and evacuation channels among said plies of graphite material for phase change material;
said graphite material being configured to absorb an amount of phase change material having a mass exceeding a mass of said graphite material, wherein the phase change material enters the graphite matrix body through said infiltration channels and infiltrates said graphite material from said infiltration channels.

2. The graphite matrix body according to claim 1, wherein the mass of phase change material impregnated in said graphite material is at least twice the mass of said graphite material.

3. The graphite matrix body according to claim 1, wherein the mass of phase change material impregnated in said graphite material is at least three times the mass of said graphite material.

4. The graphite matrix body according to claim 1, wherein a travel length of said evacuation and infiltration travel paths in said layer planes due to said structuring amount to a maximum of 200 mm.

5. The graphite matrix body according to claim 4, wherein said travel lengths of said evacuation and infiltration travel paths in the layer planes due to the structuring amount to a maximum of 50 mm.

6. The graphite matrix body according to claim 1, wherein said structuring is in the form of channels having a ratio of a depth to a width in a range of 20:1 to 1:20.

7. The graphite matrix body according to claim 6, wherein said channels are arranged parallel to said graphite layers.

8. The graphite matrix body according to claim 6, wherein said channels are arranged in a configuration selected from the group consisting of a rectilinear configuration, a meander-shaped configuration, or a herringbone shape configuration.

9. A latent heat storage material, comprising:
a bundle formed of two or more plies of a compressible graphitic material with graphite wafers disposed in layer planes lying one above the other, said bundle having an exterior and an interior;
said plies having surfaces formed with structuring defining evacuation and infiltration paths extending from the interior to the exterior of said bundle, a travel length of said evacuation and infiltration paths in the layer planes amounting to no more than 200 mm; and
an amount of phase change material infiltrated in said compressible graphitic material.

10. A method of producing a latent heat storage material, which comprises:
providing a plurality of plies of a compressible graphitic material, and providing up to 30% of a surface of each ply with a structuring reaching the outsides of the material;
bringing two or more plies of the compressible graphitic material into contact with one another, and pressing the plies formed with the structuring at a temperature of up to 400° C. and at a pressure of between 0.1 MPa and 200 MPa.

11. The method according to claim 10, which comprises evacuating the graphite material and infiltrating the layer material with phase change material in one direction or from one side.

12. The method according to claim 10, which comprises pressing or rolling channels into the plies of compressible material, the channels having a cross section with sharp edges.

13. The method according to claim 10, which comprises milling channels into the material.
